(19) United States
(12) Patent Application Publication
(10) Pub. No.: US 2026/0352926 A1
(43) Pub. Date: Nov. 5, 2026

(54) MULTICAST LEAVE POLICY

(71) Applicant: BRITISH TELECOMMUNICATIONS PUBLIC LIMITED COMPANY, London Greater, London (GB)

(72) Inventors: Michael NILSSON, London, Greater London (GB); Arsham FARSHAD, London, Greater London (GB); Stephen APPLEBY, London, Greater London (GB)

(21) Appl. No.: 19/108,968

(22) PCT Filed: Sep. 5, 2023
(86) PCT No.: PCT/EP2023/074269

§ 371 Date: Mar. 5, 2025

(30) Foreign Application Priority Data
Sep. 12, 2022 (EP) 22195183.3

(51) Int. Cl. H04N 21/6405; H04L 65/611; H04N 21/239; H04N 21/24; H04N 21/266; H04N 21/845

(52) U.S. Cl. CPC H04N 21/6405; H04L 65/611; H04N 21/2393; H04N 21/2402; H04N 21/26616; H04N 21/8456

(57) ABSTRACT

Methods are described of managing content delivery to a client device by a proxy, relating to the proxy determining whether to leave the multicast channel it has previously joined. The aim is to decide to remain joined to the multicast channel if the client device is expected to continue to request content segments at the quality level being delivered on the multicast channel; and to decide to leave the multicast channel if the client device is likely to request a significant number of content segments at a different quality level to that being delivered on the multicast channel.

### FIELD OF THE INVENTION

This invention relates to the field of managing content delivery in a network, in particular managing content delivery using a combination of unicast and multicast.

### BACKGROUND TO THE INVENTION

Video content is currently delivered to a range of client devices using unicast delivery, where a single stream of data is transmitted to each individual client device. Web (HTTP) technology is used for the content delivery, where the content is segmented into short segment files, typically around six to ten seconds in duration, enabling each segment file to be requested by and delivered to the client device using HTTP.

Each segment may also be encoded at a set of quality levels, each with a different bit rate and hence different file size. The client device monitors its buffer level and the network throughput achieved, and determines from these at which quality to request the next segment in order to achieve a good compromise between media quality and timely delivery. This is commonly referred to as adaptive bitrate (ABR) streaming.

However, HTTP is delivered over unicast (one to one) transport, so is inefficient for delivering the same content at the same time to many client devices. Multicast (one to many) transport would be far more efficient. Yet multicast is currently rarely used for any services other than network operators' on-net linear video channels delivered to their own set-top boxes. The main reason for this is that multicast does not lend itself to open use on the Internet.

To bring the benefits of multicast scalability to HTTP-based Internet media streaming, a class of techniques known as Multicast-Adaptive Bitrate (m-ABR) is being investigated and standardised.

Multicast-Adaptive Bitrate (m-ABR) is a relatively new technology. It aims to allow more efficient delivery of ABR content over networks by enabling the use of multicast for content streams where many clients are requesting the same content at about the same time.

One ambition of many m-ABR systems is to deploy multicast and enable m-ABR without any change to the client device and the client application that are already supporting HTTP (unicast) streaming. This can be achieved using a hybrid approach that uses a combination of both multicast and unicast delivery, where a proxy is inserted between the client device and the content server. The proxy can inspect content requests from the client device, and when appropriate, join to a multicast channel, receive multicast content, and provide this content to the client, packaged to look like unicast delivered content.

Examples of such hybrid solutions include: “IP Multicast Adaptive Bit Rate Architecture Technical Report” OC-TR-IP-MULTI-ARCH-C01-161026, 26/10/2016, by Cable Labs; 3GPP specifications, 23.246 (MBMS Architecture and functional description), 26.346 (MBMS Protocols and codecs) and 26.347 (MBMS APIs); and DVB “Adaptive Media Streaming over IP Multicast” ETSI TS 103 769 V1.1.1 (2020-11).

However, the decision as to when to join a multicast channel is not straightforward. Some solutions currently available only provide support for a single ABR/quality level, and prevent the client device from adapting to a different quality level by signalling that the content is only available at that single quality level. However, this gives a poor user experience with interruptions to the presentation of content at the client device when data is not delivered over the network in time. Such interruptions may cause the presentation of content to stall and/or some content not to be presented at all. Corresponding issues arise when deciding when best to leave a multicast channel, with further network inefficiencies resulting from keeping joined to a multicast channel if it is not being used.

### SUMMARY OF THE INVENTION

It is the aim of examples of the present invention to provide an improved method of joining a multicast group.

According to one aspect of the invention, there is provided a method of managing content delivery to a client device by a network element as set out in in claim 1.

According to another aspect of the invention, there is provided a network element as set out in claim 10.

Methods are described of a proxy joining a multicast channel to satisfy the requests from a client device for content segments. Having joined the multicast channel, a decision can then be made as to when to leave the multicast channel, as covered by examples of the invention. The decision to join is made taking into account the impact that joining the multicast channel could have on the network connection from the content source to the proxy, as well as the segments being requested.

In effect, the decision to leave a multicast channel is based on the likelihood of the client device requesting a significant number of content segments at a different quality level to that being delivered on the multicast channel. The approaches taken to do this is described in examples of the present invention.

While using multicast to satisfy some requests from a client for content segments would reduce the amount of unicast traffic served from the content source to the proxy, receiving content segments by multicast that are not requested by the client device, because it has requested the same content but at a different quality level, would waste some capacity on the network connection from the content source to the proxy. This is because the same content would be delivered at one unwanted quality level by multicast and at the desired quality level by unicast.

The methods described address this issue by taking into account the effect on the bandwidth on the network connection from the content source to the proxy if a multicast channel is joined. Thus, by taking into consideration the impact of joining the multicast channel on the bandwidth of the network, the proxy can avoid joining a multicast channel when it reduces the available bandwidth below certain limits, and also leave the multicast channel when appropriate.

### BRIEF DESCRIPTION OF THE DRAWINGS

For a better understanding of the present invention reference will now be made by way of example only to the accompanying drawings, in which:

FIG. 1 system diagram showing the main components of an example of the present invention; and

FIG. 2 is a flow chart summarising the steps of an example of the invention;

FIG. 3 is a flow chart summarising further steps of an example of the invention.

FIG. 4 is graph showing the parameters Join Threshold and Leave Threshold vary in examples of the invention.

### DESCRIPTION OF PREFERRED EMBODIMENTS

The present invention is described herein with reference to particular examples. The invention is not, however, limited to such examples.

Described are methods of managing content delivery to a client device by a proxy, where the content is made up of a sequence of content segments and each segment is encoded at a plurality of bit rates or quality levels. The proxy starts off by receiving content requests from the client device over unicast, and fulfilling those requests by forwarding them to a content server. In response, the proxy receives the content over unicast from the content server and forwards it onto the client device. At some stage, the proxy determines whether to join a multicast channel in order to satisfy the requests from the client device for content segments, where the decision is made taking into account the quality levels of the segments requested, as well as the impact that joining the multicast channel could have on bandwidth of the network connection from the content source to the proxy. These examples can be viewed as multicast join policies.

Other examples of the invention cover methods of managing content delivery to a client device by a proxy, but relate to the proxy determining whether to leave the multicast channel it has previously joined. The aim is to decide to remain joined to the multicast channel if the client device is expected to continue to request content segments at the quality level being delivered on the multicast channel; and to decide to leave the multicast channel if the client device is likely to request a significant number of content segments at a different quality level to that being delivered on the multicast channel.

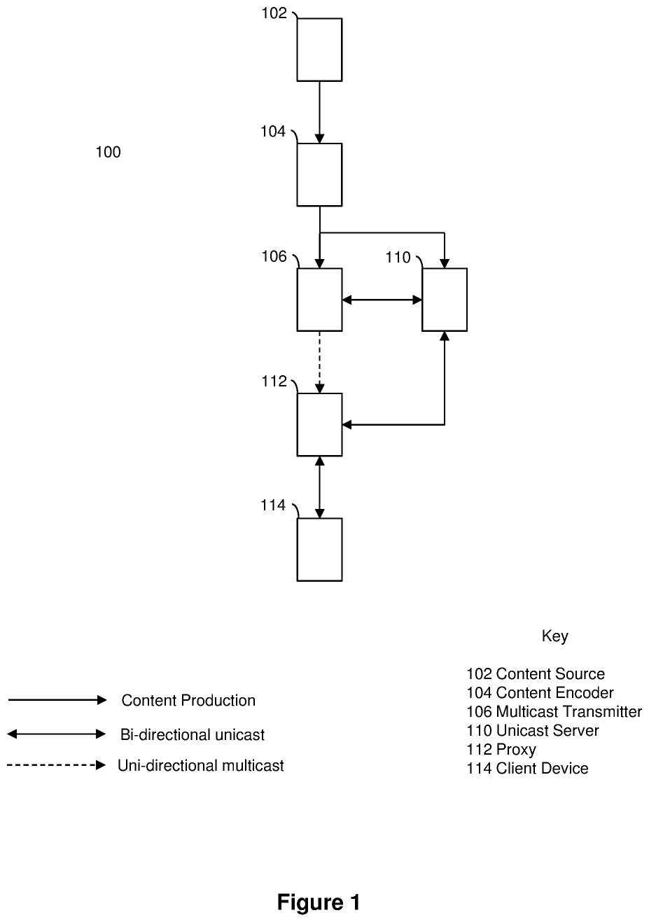

FIG. 1 shows an adaptive bit rate (ABR) streaming system 100 comprising the main components of an example of the invention. The system 100 comprises a content source 102, a content encoder 104, a multicast transmitter 106, a unicast content server 110, a proxy 112 and a client device 114. The content source 102 provides content, such as a live sports or TV broadcast, in the form of video sequences to the content encoder 104.

The proxy 112 may be located within a device such as a home gateway or router.

The client device 114 is assumed to be running a client application, which is the source of content requests. For simplicity, the term client device has been used to refer to a client device running a client application.

The content encoder 104 receives the content from the content source 102 and encodes it using a suitable compression scheme, such as ITU-T Recommendation H.264 for video content, and segments the encoded content into a sequence of content segments, each content segment typically of duration 2 to 10 seconds. The content encoder 104 also encodes the content at one or more quality levels or bit rates, resulting in one or more (at each quality level) encoded content segments corresponding to each uncompressed content segment. Such an arrangement is typical of an adaptive bit rate (ABR) streaming service.

The content encoder 104 passes the encoded content segment data, encoded at all of the required bit rates, to the unicast server 110 where the data is stored and made available for delivery by unicast. The unicast server 110 responds to unicast requests for content segments with unicast responses using the stored data.

The content segments encoded at one quality level, corresponding to one encoded bit rate, are passed to the multicast transmitter 106 for transmission by multicast to any devices that have subscribed to the respective multicast channel. However, the invention is not limited to this case, and also applies when content segments encoded at a plurality of quality levels, corresponding to a plurality of encoded bit rates, are passed to the multicast transmitter 106 for transmission by multicast on a plurality of multicast channels (one channel per quality level).

The multicast transmitter 106 may start to transmit content segments before, at the same time, or after they have been made available on the unicast server 110. The multicast transmitter 106 may transmit content segments at a constant bit rate, approximately equal to their encoding rate, to fully utilise the multicast channel, or may transmit them at a faster rate.

The multicast transmitter 106 may be configured in one of various modes of operation.

In one mode of operation, the unicast server 110 monitors the requests for content segments made by a plurality of client devices. When the unicast server 110 determines that a sufficient number of client devices have requested the same content segment at about the same time, it instructs the multicast transmitter 106 to transmit the content segment on the multicast channel, in the expectation that it would subsequently be requested by additional client devices. The multicast transmitter 106 obtains the content segment from the unicast server 110 and converts the content segment data into a format suitable for multicast delivery, and then transmits it on the multicast channel to all devices that have subscribed to that multicast channel

In another mode of operation, the multicast transmitter 106 is configured for specific content, such as a television channel, at a specific encoding quality level. Content segments encoded at the specific quality level, corresponding to one encoded bit rate, are passed from the content encoder 104 to the multicast transmitter 106 for transmission by multicast to all the devices that have subscribed to the respective multicast source.

However, the invention is not limited to these two configurations of the multicast transmitter 106.

To request content segments, the client device 114 can first obtain a manifest file from the unicast server 110. Manifest files are used by client devices to identify where content segments are located (by a URL in the manifest). The client device 114 can then request these content segments in sequence using HTTP requests from the unicast server 110, and concatenate them to form a continuous stream of content segments for playback. As each content segment is available on the unicast server 110 at a plurality of encoded bit rates, the client device 110 determines for each content segment, the encoded bit rate (quality) at which to request it, taking into account such factors as the available network throughput and how much data is already received and buffered at the client device awaiting play-out.

Some HTTP requests made by the client device 114 for content will not make use of multicast delivery and are sent directly to the unicast server 110, which delivers the requested content by unicast. Other requests for content from the client device 114 that may benefit from multicast delivery are re-directed to, or simply intercepted by, the proxy 112, and can be handled in accordance with the examples described below.

The proxy 112 can be inserted in the HTTP path using any of a number of well-known techniques, such as using an HTTP redirection from the unicast server 110. In this case, the unicast server 110 would be configured such that requests for potentially popular content are not served directly but instead redirected to a suitable proxy. For example, instead of supplying a normal response, the unicast server 110 could respond with an HTTP status code 307 which indicates a temporary redirect. This invites the client device 114 to make a new request to the new URL supplied by the unicast server 110 in its response, thus enabling requests to be made to the proxy 112. This technique allows the unicast server 110 and the proxy 112 to exist in different domains, which would often be the case.

Other mechanisms to insert the proxy 112 in the HTTP path include: proxy configured as a transparent proxy (though all requests are intercepted by it, and only works with unencrypted traffic); proxy configured as a forward proxy (where the client device sends its requests directly to the proxy by virtue of being explicitly configured to do so); DNS hijacking (where a DNS server is configured to supply the IP address of the proxy for domains of interest); and manifest manipulation (where the manifest file is re-written so that requests are made directly to the proxy).

The client device 114 could request and receive content segments from the unicast server 110 from the start to the end of a streaming session. However, in some cases the proxy 112 determines that multicast delivery could be used to receive some content segments.

The proxy 112 monitors unicast content requests from the client device 114 and is aware of when content requested by the client device 114 could be received by multicast.

The proxy 112 determines whether it should join a multicast channel to satisfy the client device's requests for content using data that is delivered by multicast, and if so, joins the relevant multicast channel at an appropriate time. After receiving data by multicast, the proxy replies to the client device's requests for unicast content with content received by multicast, but packaged as unicast content responses.

If the proxy 112 has joined a multicast channel, the proxy 112 determines whether it should remain joined to the multicast channel or whether it should leave. In the case of deciding to leave, the proxy 112 leaves the multicast channel, and returns to satisfying the client device's requests for unicast content by requesting the content from the unicast server 110 and delivering it to the client device 114 as unicast content responses.

The client device 114 does not need to be aware of the proxy 112 and does not need to be aware of whether content is being delivered by unicast from the unicast server 110 via the proxy 112, or is delivered by multicast to the proxy 112 which then delivers the content to the client device 114 in a unicast format.

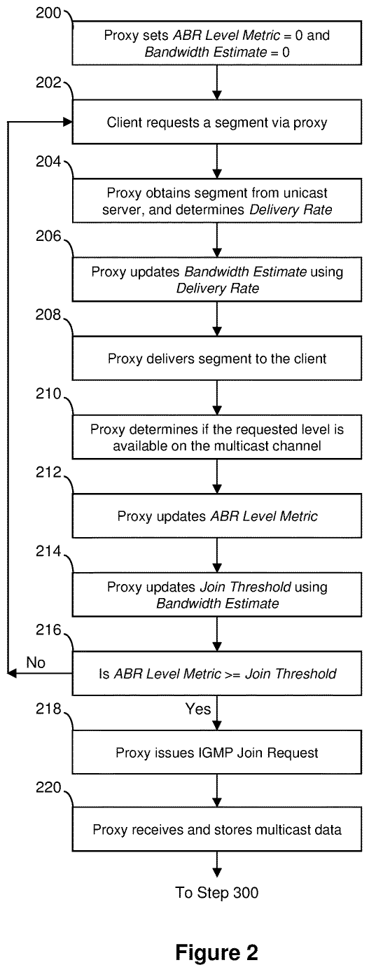

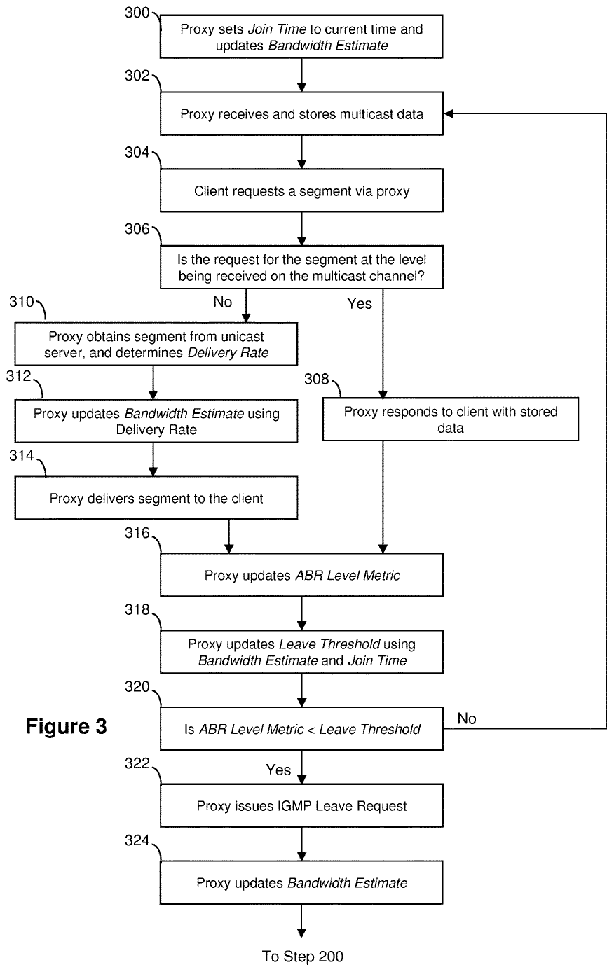

Described now is a detailed example of how the proxy 112 can determine whether to join a multicast channel, and if deciding to do so and joining a multicast channel, how the proxy 112 can determine whether to leave the multicast channel. There then follows a summary of the steps of the example described with reference to the flow charts of FIGS. 2 and 3.

Starting with the detailed example, the proxy 112 maintains a parameter termed ABR Level Metric. In the case that content segments encoded at a plurality of quality levels, corresponding to a plurality of encoded bit rates, are available on respective multicast channels (one channel per quality level), the proxy 112 maintains an instance of the parameter ABR Level Metric for each of these multicast channels. The ABR Level Metric is a parameter indicative of the number or proportion of recent requests made by the client device 114 for content segments at the quality level of the content segments available on the respective multicast channel. Thus, the ABR Level Metric is higher when the number or proportion of recent requests made by the client device 114 for content segments at the quality level of the content segments available on the respective multicast channel is higher, and the ABR Level Metric is lower when the number or proportion of recent requests made by the client device 114 for content segments at the quality level of the content segments available on the respective multicast channel is lower.

The proxy 112 also maintains a parameter termed Bandwidth Estimate which is indicative of the bandwidth available between the content server 110 and the proxy 112 for the delivery of content segments by unicast delivery.

The proxy 112 initially sets the value if each instance of ABR Level Metric to zero, and sets Bandwidth Estimate to zero.

The proxy 112 receives requests for content segments from the client device 114, forwards these to the unicast server 110, receives the corresponding responses and forwards these to the client device 114.

The proxy 112 determines the rate at which the content segment is received from the unicast server 110 and stores the determined value in the parameter Delivery Rate. The proxy 112 can, for example, determine the value of Delivery Rate as the size of the content segment divided by the time taken to receive the content segment.

The proxy 112 then determines a value for Bandwidth Estimate in any of a number of different ways, using one or more previously determined values of Delivery Rate. For example, the proxy 112 can determine the value of Bandwidth Estimate as the average of the most recent N values of Delivery Rate, or as the maximum, minimum or median of these values, or using some similar approach. The average could be calculated for example as the arithmetic, geometric or harmonic mean of the values of Delivery Rate. N could be any integer greater than or equal to one. Alternatively, instead of using a fixed value of N, the proxy 112 could use all values of Delivery Rate determined in the preceding period of time T, where T could, for example, be 60 seconds or any other period of time.

For each content request from the client device 114, the proxy 112 compares the quality level at which the content segment has been requested with the quality levels available on the one or more multicast channels. If the requested quality level is available on the multicast channel with index i, the proxy 112 sets the variable Lᵢ equal to one, otherwise sets Lᵢ equal to zero.

Then for each multicast channel, i, the proxy 112 updates the value of the parameter ABR Level Metric for that channel, ABR_LMᵢ, using the value of variable Lᵢ.

The parameter ABR Level Metric can be calculated in any one of many ways. The following are three example methods. However, other methods can be used.

In a first example method, ABR_LMᵢ, is calculated as the number of consecutive segment requests made by the client device 114 for content segments at the quality level available on the multicast channel with index i. In this case, ABR_LMᵢ, is updated according to Equation 1 below:

$${ABR\_LM}_{i} ← \{ \begin{matrix}{ABR\_LM}_{i} + 1 & if {L}_{i} = 1 \\ 0 & otherwise\end{matrix} \qquad Equation 1$$

In a second example method, ABR_LMᵢ, is calculated using a sliding window of M requests for content segments, that is, ABR_LMᵢ, is calculated as sum of the M most recent values of Lᵢ, with, for example, zero being used instead of what would have been the corresponding Lᵢ, if there have not yet been M requests for content segments by the client device 114. In this case, ABR_LMᵢ, is calculated as below according to Equation 2, where Lᵢ (t) is the most recent value of Lᵢ and Lᵢ(t−n) is the value of Lᵢ for the previously requested content segment since when n further content segments have been requested.

$${ABR\_LM}_{i} = {\sum }_{j = t - M + 1}^{t} {L}_{i} ( j ) \qquad Equation 2$$

M could, for example, be set to the value of ten content segments, or to any other value.

In a third example method, ABR_LMᵢ, is calculated using an Infinite Impulse Response (IIR) applied to the values of Lᵢ. That is, the previous value of ABR_LMᵢ is scaled by a factor, f, and added to the latest value of Lᵢ scaled by one minus this factor (scaled by 1−f). In this case, ABR_LMᵢ, is updated according to Equation 3 below.

ABR_LMᵢ←ƒ×ABR_LMᵢ+(1−f)×Lᵢ Equation 3

The factor f should be set to a value between zero and one, where larger values of the factor f cause ABR_LMᵢ to be influenced by a larger number of values of Lᵢ. The factor f could, for example, be set to the value 0.85.

As described in more detail later, the proxy 112 will join a multicast channel if the determined value of ABR Level Metric for that multicast channel is greater than or equal to a threshold for that multicast channel. Here, the threshold is given by the parameter Join Threshold. After joining the multicast channel, the proxy 112 will be able to satisfy requests for content segments from the client device 114 from data that has been received on the multicast channel and stored at the proxy 112, provided that these content segments are requested at the quality level that is delivered on the multicast channel. Any content segments requested by the client device 114 at a different quality level will have to be satisfied by requesting them from the unicast server 110. In this latter case, the proxy 112 will receive the requested segment by unicast, and the same content segment, at a different quality level, on the multicast channel.

If there is plenty of bandwidth between the unicast server 110 and the proxy 112, then occasionally delivering the same content segment at more than one quality level to the proxy 112 may not present a problem. However, in some cases there may be insufficient bandwidth between the unicast server 110 and the proxy 112 to simultaneously deliver the same content segment at more than one quality level, or in other cases, only just enough bandwidth to do so. In each of these latter cases, delivery of the requested content segment to the client device 114 may be delayed enough to cause stalling of media play-out at the client device 114 or cause the client device 114 to request subsequent content segments at an even lower quality. This behaviour is highly undesirable.

While the intention is for the proxy 112 to only join the multicast channel if the client device 114 is expected to continue to request content segments at the quality level being delivered on the multicast channel, the importance of getting the decision to join the multicast channel correct is greater when there is less bandwidth between the unicast server 110 and the proxy 112, as the consequences of getting the decision wrong has more impact on the quality of experience presented on the client device 114.

The proxy 112 therefore determines a value for Join Threshold for each multicast channel using the determined value of Bandwidth Estimate. The higher the value of Bandwidth Estimate, the more optimistic the proxy 112 can be about joining the multicast channel.

The proxy 112 therefore sets the value for Join Threshold to a higher value when the value of Bandwidth Estimate is lower and sets the value for Join Threshold to a lower value when the value of Bandwidth Estimate is higher.

The proxy 112 also determines the value for Join Threshold in dependence on the method used to calculate the value of ABR Level Metric. In the case of using the first (consecutive requests) or second (sliding window) methods described earlier, the value of ABR Level Metric will be an integer, whereas in the case of using the third (IIR) method described earlier, the value of ABR Level Metric will be a rational value between zero and one.

The following is one example of a method that the proxy 112 could use to set the value of Join Threshold in the case of using the third (IIR) method to calculate ABR Level Metric described earlier. The invention is not limited to this example method, and other methods could be used.

The proxy 112 may be aware of the data rate of the multicast channel. But if this is not known, the proxy 112 could estimate a value of the multicast channel data rate from the size of segments at the quality level that is available on the multicast channel divided by the segment interval, which is the typical time between consecutive requests for segments.

If the Bandwidth Estimate is less than 1.25 times the data rate of the multicast channel, the proxy 112 may set Join Threshold to a value higher than ABR Level Metric could ever be, so that it is never decided to join the multicast channel as joining the multicast channel in this case would leave little bandwidth to deliver segments by unicast if the client device 114 were to request content segments at a quality level different to that delivered on the multicast channel. An example of such a value of Join Threshold may be 1.01.

If the Bandwidth Estimate is more than 3 times the data rate of the multicast channel, the proxy 112 may set Join Threshold to a minimal value, so that it can be decided to join the multicast channel when there is a reasonable percentage of requests for content segments at the quality level delivered on the multicast channel. An example of such a value of Join Threshold may be 0.50.

If the Bandwidth Estimate is between these two extremes of the data rate of the multicast channel, the proxy 112 may set Join Threshold linearly between these extremes.

In this example method, the proxy 112 would calculate Join Threshold, JTᵢ, for multicast channel i, as shown in Equation 4 below, where r is the ratio of Bandwidth Estimate to the data rate of multicast channel i.

$$J {T}_{i} = \{ \begin{matrix}1.01 & if r < 1.25 \\ 1.01 - 0.51 \frac{r - 1.25}{1.75} & if 1.25 \leq r \leq 3. \\ 0.5 & if r > 3.\end{matrix} \qquad Equation 4$$

Then for each multicast channel, i, the proxy 112 determines whether the value of the parameter ABR Level Metric for that channel, ABR_LMᵢ, is greater than or equal to the value of Join Threshold for that channel, JTᵢ, and if so, determines to join multicast channel i.

In some cases, by following this procedure, it may be possible that the proxy 112 determines to join more than one multicast channel. If so, then the proxy 112 selects one of these multicast channels to join and does not join the others. For example, it may determine to join the one of these multicast channels with the highest data rate, that is, the one that is delivering the higher or highest quality level.

If the proxy 112 has determined to join a multicast channel, the proxy 112 initiates the process of joining the multicast channel. This may be done for example by issuing an IGMP Join request.

The proxy 112 sets the value of a parameter Join Time equal to the time at which the proxy 112 joins the multicast channel.

The proxy 112 also updates the parameter Bandwidth Estimate to take into account that the proxy 112 has joined the multicast channel, and less bandwidth is therefore available for unicast delivery of content segment requests. The proxy 112 reduces the value of Bandwidth Estimate by the data rate of the multicast channel that it has joined.

While the proxy 112 is joined to a multicast channel, it receives data on the multicast channel and stores that data.

The proxy 112 intercepts a request for a content segment from the client device 114.

The proxy 112 compares the quality level at which the content segment has been requested with the quality levels available on the one or more multicast channels. If the quality level is available on the multicast channel with index i, the proxy 112 sets the variable Lᵢ equal to one, and otherwise sets Lᵢ equal to zero.

The proxy 112 determines whether the content segment requested by the client device 114 is at a quality level that is available on the multicast channel that it has joined and has been received and stored at the proxy 112.

If so, the proxy 112 then delivers that content segment received over multicast to the client device 114, with the data formatted as a unicast response.

If the content segment requested by the client device 114 is not stored at the proxy 112, the proxy 112 forwards the request to the unicast server 110, receives a response and forwards the response to the client device 114.

As in the process for when the proxy 112 was not joined to a multicast channel, the proxy 112 determines the rate at which the content segment is received from the unicast server 110 and stores the determined value in the parameter Delivery Rate, and the proxy 112 then determines a value for Bandwidth Estimate using one or more previously determined values of Delivery Rate.

Then, regardless of whether the proxy 112 used stored data or made a request to the unicast server 110 to satisfy the request from the client device 114, for each multicast channel, i, the proxy 112 updates the value of the parameter ABR Level Metric for that channel, ABR_LMᵢ, using the value of variable Lᵢ.

Compared to when the proxy 112 was not joined to a multicast channel, the method used to calculate ABR Level Metric may be changed. The second and third methods described earlier, which make use of a sliding window or IIR filter to calculate ABR Level Metric, can be used unchanged. However, the first method, in which consecutive requests at the same quality level are counted, is not suitable as a metric for determining whether to leave the multicast channel. In this case this metric could continue to be determined for each multicast channel, but in addition, one or more other parameters could be determined in relation to the multicast channel that has been joined. For example, the number of requests from the client device 114 for content segments that are not available on the multicast channel could be counted and used as the metric for determining when to leave the multicast channel. And in this case, the method could, for example, be further extended by resetting this count of segments to zero when the count of consecutive requests from the client device 114 for content segments that are available on the multicast channel reaches a threshold, that threshold being the same or similar to the threshold that would have been applied to determine whether to join the multicast channel had this not already happened. This is to avoid determining to leave the multicast channel after a number of requests from the client device 114 for content segments that are not available on the multicast channel, when these requests are interleaved into a large number of requests for content segments that are available on the multicast channel.

As described in more detail later, the proxy 112 will leave the multicast channel if the determined value of ABR Level Metric for that multicast channel is less than a certain threshold set by the value of the parameter Leave Threshold for that multicast channel.

The aim is that the proxy 112 leaves the multicast channel when the client device 114 makes a significant percentage of requests for content segments at quality levels not delivered on the multicast channel.

Similar to the reasoning presented earlier for when the proxy 112 was not joined to a multicast channel, such significance depends on the relationship of the data rate of the multicast channel that is joined and Bandwidth Estimate, which now indicates the bandwidth available between the unicast server 110 and the proxy 112, after the deduction of the data rate of the multicast channel.

Such significance also depends on the amount of time that has elapsed since the proxy 112 joined the multicast channel, which the proxy 112 can determine having stored the time of joining the multicast channel in the parameter Join Time. In some cases, the act of joining the multicast channel may affect the quality level decisions made by the client device 114, for example, because the time taken to respond to requests for content segments from the client device 114 may have changed due to the relative timing of data on the multicast channel and the timing of the requests for content segments.

The proxy 112 therefore determines a value for Leave Threshold using either the determined value of Bandwidth Estimate, the time that has elapsed since the proxy 112 joined the multicast channel, or both.

The higher the value of Bandwidth Estimate, the more optimistic the proxy 112 can be about remaining joined to the multicast channel. The proxy 112 therefore sets the value for Leave Threshold to a higher value when the value of Bandwidth Estimate is lower and sets the value for Leave Threshold to a lower value when the value of Bandwidth Estimate is higher.

The more time that has elapsed since the proxy 112 joined the multicast channel, the less likely it is that the act of joining has caused the client device 114 to request content segments at a different quality level to those delivered on the multicast channel. The proxy 112 therefore sets the value for Leave Threshold to a higher value when the elapsed time is lower and sets the value for Leave Threshold to a lower value when the elapsed time is higher.

The proxy 112 also determines the value for Leave Threshold in dependence on the method used to calculate the value of ABR Level Metric. In the case of using the first (consecutive requests) or second (sliding window) methods described earlier, the value of ABR Level Metric will be an integer, whereas in the case of using the third (IIR) method described earlier, the value of ABR Level Metric will be a rational value between zero and one.

The following is one example of a method that the proxy 112 could use to set the value of Leave Threshold in the case of using the third (IIR) method to calculate ABR Level Metric described earlier. The invention is not limited to this example method, and other methods could be used.

The proxy 112 may be aware of the data rate of the multicast channel. But if this is not known, the proxy 112 could estimate a value from the size of segments at the quality level that is available on the multicast channel divided by the segment interval, which is the typical time between consecutive requests for segments.

If the Bandwidth Estimate is less than zero, that is, the calculated bandwidth between the unicast server 110 and the proxy 112 is less than the data rate of the multicast channel, the proxy 112 may set Leave Threshold to a value higher than ABR Level Metric could ever reach, so that a decision is made to leave the multicast channel. Such a value of Leave Threshold may be 1.01.

If the Bandwidth Estimate is more than 2 times the data rate of the multicast channel, the proxy 112 may set Leave Threshold to a minimal value, so that it can be decided to remain joined to the multicast channel while a reasonable percentage of requests for content segments are at the quality level delivered on the multicast channel. This value of Leave Threshold may be set lower than the corresponding value of Join Threshold to provide hysteresis in the join and leave decisions and avoid flip-flopping between joining and leaving. Such a value of Leave Threshold may be 0.40.

If the Bandwidth Estimate is between these two extremes of the data rate of the multicast channel, the proxy 112 may set Leave Threshold linearly between these extremes.

In this example, the proxy 112 would calculate Leave Threshold, LT, as shown by Equation 5 below, where r is the ratio of Bandwidth Estimate to the data rate of multicast channel.

$$LT = \{ \begin{matrix}1.01 & if r < 0. \\ 1.01 - 0.61 \frac{r}{2.} & if 0. \leq r \leq 2. \\ 0.4 & if r > 2.\end{matrix} \qquad Equation 5$$

If the elapsed time is less than a threshold, for example, less than 30s, the proxy 112 may use a higher value of Leave Threshold, whereas if the elapsed time is higher, may use a lower value of Leave Threshold. The proxy 112 may instead not apply a threshold to the elapsed time and instead set the value of Leave Threshold as a continuous function of the elapsed time, where the continuous function may be a monotonically decreasing function.

In this example of just using a threshold on the elapsed time, the proxy 112 would calculate Leave Threshold, LT, as shown in Equation 6 below, where r is the ratio of Bandwidth Estimate to the data rate of multicast channel, and ET is equal to one if the elapsed time is less than 30s, otherwise ET is equal to zero.

$$J {T}_{i} = \{ \begin{matrix}1.01 & if r < 0.12 \times ET \\ 1.01 - ( 0.61 - 0.05 \times ET ) \frac{r}{2.} & if 0.12 \times ET \leq r \leq 2. \\ 0.4 + 0.05 \times ET & if r > 2.\end{matrix} \qquad Equation 6$$

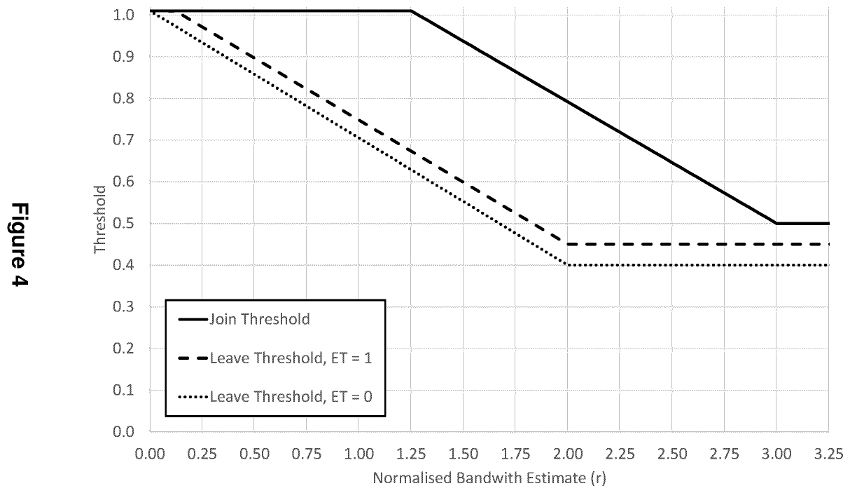

FIG. 4 shows how Join Threshold and Leave Threshold (with ET=1 and ET=0), vary as functions of r for these example methods of calculating the thresholds.

If the proxy 112 has determined to leave the multicast channel, the proxy 112 initiates the process of leaving the multicast channel. This may be done for example by issuing an IGMP Leave request.

In another example of the invention, while the proxy 112 is joined to a multicast channel, it does not use the parameter termed Leave Threshold, and does not compare ABR Level Metric with Leave Threshold to determine whether to leave the multicast channel. Instead, the proxy 112 operates the process described earlier for when not joined to a multicast channel, but with the following changes.

The proxy 112 maintains instances of the parameter ABR Level Metric for each multicast channel. The value of the instance of ABR Level Metric for the multicast channel that has been joined is compared with the corresponding instance of Join Threshold, and if greater than or equal to this threshold, no further action is taken. Otherwise, the value of each other instance of ABR Level Metric is compared with the corresponding instance of Join Threshold, and if one or more of these is greater than or equal to the corresponding threshold, the proxy 112 determines to leave the multicast channel to which it is currently joined and determines to join the multicast channel corresponding to this instance of ABR Level Metric. In the case of more than one instance of ABR Level Metric being greater than or equal to the corresponding threshold, the proxy 112 chooses one, and joins the corresponding multicast channel.

In this example of the invention, the proxy 112 remains joined to a multicast channel until requests from the client device 114 meet the criteria to join another multicast channel, at which time the proxy 112 leaves the current multicast channel and joins the other. Turning now to the flow chart of FIG. 2. The flow chart of FIG. 2 summarises the steps of an example of the present invention in which the proxy 112 determines whether to join a multicast channel in which there is only a single multicast channel available and therefore only one instance of the parameter ABR Level Metric and one instance of the parameter Join Threshold. This flow chart presents a simplified summary of the methods already described above.

Starting at step 200, the proxy 112 sets the parameters ABR Level Metric and Bandwidth Estimate to zero.

In step 202, the client device 114 makes a request for a content segment stored at the unicast server 110. The proxy 112 intercepts this request.

The client device 114 can request content segments using HTTP GET requests, which are unicast in nature, directed to content segments encoded at a particular bit rate or quality level. This initial quality level may be chosen to be the lowest quality level available, or the initial quality level could be chosen in some other way, such as based on historical data or user preference. Each HTTP GET request includes the URL of where that content segment can be retrieved from. The URLs are found in the manifest file associated with the content.

In step 204, the proxy 112 obtains the requested content segment by unicast from the unicast server 110. The proxy 112 determines the rate at which the content segment is received from the unicast server 110 and stores the determined value in the parameter

### Delivery Rate.

In step 206, the proxy 112 updates its estimate of the bandwidth, stored in parameter Bandwidth Estimate, of the connection between it and the unicast server 110. As already described earlier, the proxy 112 could determine the value of Bandwidth Estimate in any of many different ways using one or more previously determined values of Delivery Rate.

In step 208, the proxy 112 forwards the content segment data received from the unicast server 110 to the client device 114 as a unicast response to the request from the client device 114. The client device 114 receives this content segment, which can then be played out.

In step 210, the proxy 112 determines whether the content segment requested by the client device 114 is at a quality level that is available on the multicast channel, and if so, sets parameter L equal to one, and otherwise sets L equal to zero.

In step 212, the proxy 112 updates the parameter ABR Level Metric. This could be performed using any of the methods described earlier.

In step 214, the proxy 112 updates the parameter Join Threshold using Bandwidth Estimate. This could be performed using any of the methods described earlier.

In step 216, the proxy 112 compares the parameter ABR Level Metric to the threshold parameter Join Threshold and if ABR Level Metric is greater than or equal to the threshold, flow passes to step 218. Otherwise flow passes to step 202.

In step 218, the proxy 112 having observed the client device 114 making a sufficient number of requests for content segments that are available on the multicast channel, that is, by determining that ABR Level Metric is greater than or equal to the value of Join Threshold, determines to join the multicast channel.

The proxy 112 initiates the process of joining the multicast channel. This may be done for example by issuing an IGMP Join request.

In step 220, the proxy 112 receives data on the multicast channel and stores that data.

While the proxy 112 is joined to the multicast channel, the client device 114 continues to make requests for content segments stored at the unicast server 110. The proxy 112 intercepts these requests and responds to the client device 114 with unicast responses including data that has either been received on the multicast channel and stored, or, if the requested data has not been received on the multicast channel, including data that it has requested and received over unicast from the unicast server 110. The content segments are received by the client device 114, and can then be played-out.

This is described in more detail with reference to FIG. 3, which shows a flow chart summarising the steps of an example of the present invention in which the proxy 112 has already joined a multicast channel and determines whether to leave the multicast channel. In this simplified example, there is only a single multicast channel and therefore only one instance of the parameter ABR Level Metric and only one instance of the parameter Leave Threshold. This flow chart presents a simplified summary of the methods already described above.

Starting at step 300, the proxy 112 sets the parameter Join Time to the current time. Join Time stores the time at which the proxy 112 joined the multicast channel. The proxy 112 also updates the parameter Bandwidth Estimate to take into account that the proxy 112 has joined the multicast channel, and less bandwidth is therefore available for unicast delivery of content segments. The proxy 112 reduces the value of Bandwidth Estimate by the data rate of the multicast channel. This may be known, but if not, the proxy 112 could estimate a value from the size of segments at the quality level that is available on the multicast channel divided by the segment interval, which is the typical time between consecutive requests for segments.

In step 302, the proxy 112 receives data on the multicast channel and stores that data.

In step 304, the client device 114 makes a request for a content segment stored at the unicast server 110. The proxy 112 intercepts this request.

In step 306, the proxy 112 determines whether the content segment requested by the client device 114 is at a quality level that is available on the multicast channel and has been received and stored at the proxy 112, and if so, flow passes to step 308. Otherwise flow passes to step 310.

In step 308, the proxy 112 responds to the client device 114 with a unicast response including data that had been received on the multicast channel and stored. The content segment is received by the client device 114, and can then be played-out. Flow then passes to step 316.

In step 310, the proxy 112 obtains the requested content segment by unicast from the unicast server 110. The proxy 112 determines the rate at which the content segment is received from the unicast server 110 and stores the determined value in the parameter Delivery Rate. The proxy could determine the value of Delivery Rate using the same method as in step 204.

In step 312, the proxy 112 updates its estimate of the bandwidth, stored in parameter Bandwidth Estimate, of the connection between it and the unicast server 110. The proxy 112 could determine the value of Bandwidth Estimate using the same method as in step 206, but taking into account that the proxy 112 has joined the multicast channel and therefore less bandwidth is available for unicast content segment requests.

In step 314, the proxy 112 forwards the content segment data received from the unicast server 110 to the client device 114 as a unicast response to the request from the client device 114. The client device 114 receives this content segment, which can then be played out.

In step 316, the proxy 112 updates the parameter ABR Level Metric. This could be performed using any of the methods described earlier.

In step 318, the proxy 112 updates the parameter Leave Threshold using Bandwidth Estimate and the time that has elapsed since joining the multicast channel. This could be performed using any of the methods described earlier.

In step 320, the proxy 112 compares the parameter ABR Level Metric to the threshold parameter termed Leave Threshold and if ABR Level Metric is less than the threshold, flow passes to step 322. Otherwise flow passes to step 302.

In step 322, the proxy 112 having observed the client device 114 making a sufficient number of requests for content segments that are not available on the multicast channel, that is, by determining that ABR Level Metric is less than the value of Leave Threshold, determines to leave the multicast channel.

The proxy 112 initiates the process of leaving the multicast channel. This may be done for example by issuing an IGMP Leave request.

In step 324, the proxy 112 updates the parameter Bandwidth Estimate to take into account that the proxy 112 has left the multicast, and more bandwidth is therefore available for unicast content segment requests. The proxy 112 increases the value of Bandwidth Estimate by the data rate of the multicast channel that is has just left. Flow then passes back to step 200.

In general, it is noted herein that while the above describes examples of the invention, there are several variations and modifications which may be made to the described examples without departing from the scope of the present invention as defined in the appended claims. One skilled in the art will recognise modifications to the described examples.

1. A method of managing content delivery to a client device by a network element, said content comprising a sequence of segments and wherein each of the segments is encoded at a plurality of quality levels, said method comprising:
i) receiving unicast requests for segments encoded at one or more of the quality levels from a client device, forwarding the requests to a unicast content source, receiving the requested segments, and transmitting the requested segments to the client device by unicast;
ii) determining the time taken to receive each given segment and the size of each given segment, and estimating a delivery rate for each given segment as the quotient of the size of the segment and the time taken to receive the segment;
iii) determining a bandwidth estimate as an average of the estimated delivery rates;
iv) joining a multicast channel, receiving segments over multicast, and transmitting segments requested by the client device to the client device by unicast;
v) calculating an ABR level metric based on the number of unicast requests from the client device for content segments at the quality level delivered over the multicast channel;
vi) determining to leave the multicast channel in dependence on the bandwidth and the quality level metric;
vii) leaving the multicast channel, receiving segment requests over unicast, and forwarding the requests to a unicast content source, receiving the requested segments, and transmitting the requested segments to the client device by unicast.

2. A method according to claim 1, wherein determining to leave comprises comparing the quality level metric to a threshold, and where the threshold is dependent on the determined bandwidth.

3. A method according to claim 2, wherein the threshold is higher when the determined bandwidth is lower and threshold is lower when the determined bandwidth is higher.

4. A method according to claim 2, wherein the threshold is further dependent on the time since joining the multicast channel.

5. A method according to claim 4, wherein the threshold is higher when the time since joining the multicast channel is lower, and the threshold is lower when the time since joining the multicast channel is higher.

6. A method according to claim 2, wherein determining to leave comprises determining if the quality level metric is less than the threshold, and leaving the multicast channel when quality level metric is less than the threshold.

7. A method according to claim 1, wherein the respective quality level metric is higher when the number of unicast requests at the quality level delivered over the multicast channel is higher, and the respective quality level metric is lower when the number of unicast requests at the quality level delivered over the multicast channel is lower.

8. A method according to claim 1, wherein the respective quality level metric is higher when the unicast requests at the quality level delivered over the multicast channel are more recent, and the respective quality level metric is lower when the unicast requests at the quality level delivered over the multicast channel are older.

9. A method according to claim 1, wherein step iii) further comprises forwarding one or more of the requests from the client device to a unicast content source, receiving the requested segments over unicast, and updating the bandwidth using the bit rate at which the one or more segments is received by the network element.

10. A network element for managing content delivery to a client device, said content comprising a sequence of segments and wherein each of the segments is encoded at a plurality of quality levels, said network element adapted to:
receive unicast requests for segments encoded at one or more of the quality levels from a client device, forward the requests to a unicast content source, receive the requested segments, and transmit the requested segments to the client device by unicast;
determine the time taken to receive each given segment and the size of each given segment, and estimate a delivery rate for each given segment as the quotient of the size of the segment and the time taken to receive the segment;
determine a bandwidth estimate as an average of the estimated delivery rates;
join a multicast channel, receiving segments over multicast, and transmit segments requested by the client device to the client device by unicast;
calculate an ABR level metric based on the number of unicast requests from the client device for content segments at the quality level delivered over the multicast channel;
determine to leave the multicast channel in dependence on the bandwidth and the quality level metric;
leave the multicast channel, receiving segment requests over unicast, and forward the requests to a unicast content source, receive the requested segments, and transmit the requested segments to the client device by unicast.
